(19) United States
(12) Patent Application Publication
(10) Pub. No.: US 2005/0066679 A1
(43) Pub. Date: Mar. 31, 2005

(54) Distributed operator cooling system

(76) Inventors: Jack Clyde Boyer, Reinbeck, IA (US); Frederick Lamont Warner, Buckingham, IA (US)

Correspondence Address: DEERE & COMPANY;Patent Department, One John Deere Place, Moline, IL, 61265-8098, US

(21) Appl. No.: 10/675,618

(22) Filed: Sep. 30, 2003

(51) Int. Cl. B60H 1/32; F25D 17/00; F25D 17/02

(52) U.S. Cl. 62/244; 62/434; 62/333

(57) ABSTRACT

A distributed operator cooling system is provided for a work vehicle. The system includes a primary circuit and a secondary loop. The primary circuit is a conventional A/C circuit having a compressor, a condenser, a receiver/dryer and an expansion valve. The secondary loop includes a coolant pump and a plurality of coolant-air heat exchangers each having a blower fan associated therewith. The secondary loop is coupled to the primary circuit by way of a coolant-refrigerant heat exchanger wherein the coolant of the secondary loop is chilled. Chilled coolant is circulated to the coolant-air heat exchangers by coolant lines and back to the pump and coolant-refrigerant heat exchanger by return lines. The coolant lines are routed through the wall of an operator's enclosure. At least one of the coolant-air heat exchangers is located in the forward area of the operator's enclosure in a front console of the vehicle substantially in front of the operator. A pair of coolant-air heat exchangers are located above and on either side, forward or aft of the operator's head. Additional heat exchangers can be provided at additional locations within the confines of the operator's enclosure for further distributed cooling and/or to compensate for potential hot spots within the cab. The blower fans associated with each coolant-air heat exchanger can be individually controlled to optimize the flow of air through the exchanger according to the needs of the operator. The use of multiple compact coolant-air heat exchangers positioned at multiple locations within the operator's enclosure allows for more efficient cooling than possible with a single large heat exchanger. The use of a secondary loop system allows for locating most of the system components remotely from the operators enclosure thereby reducing the risk of refrigerant contact with the operator and allows refrigerant lines to be shortened so as to improve the efficiency of the refrigerant cycle.

### FIELD OF THE INVENTION

The present invention relates generally to HVAC systems. More particularly, the present invention relates to A/C systems used in automotive vehicles. Specifically, the present invention relates to secondary loop type automotive A/C systems.

### BACKGROUND OF THE INVENTION

Due to recent concerns about global warming there has been an effort to replace HFCs (hydro-flouro-carbons) as refrigerants in A/C systems with more environmentally friendly alternatives. Alternatives which have been considered are CO₂ or non-inert HCs (hydrocarbons) which, while environmentally friendlier, are not considered practical in conventional A/C systems due to the potential for human contact with the refrigerant. Accordingly, secondary loop A/C systems have been considered to enable the use of CO₂ or non-inert HCs and reduce the potential for human contact. The secondary loop system is typically comprised of a primary conventional air conditioning circuit using CO₂ or an HFC or HC refrigerant and having a compressor, a condenser, a receiver/dryer, and an expansion valve. These components are coupled to a coolant fluid secondary loop comprising a coolant-refrigerant heat exchanger, a coolant pump and a coolant-air heat exchanger. The refrigerant of the primary circuit is used to chill the coolant of the secondary loop. All components except the coolant-air heat exchanger and its coolant lines are located outside the passenger compartment of the vehicle. Coolant lines for the coolant-air heat exchanger are routed to the heat exchanger located in the passenger compartment. Thus the potential for human contact with refrigerants is greatly reduced, thereby allowing for a greater range of refrigerant options. The practicalities of using non-inert HCs as a replacement for HFCs in automotive A/C systems is discussed in SAE Publication No. 1999-01-0874 entitled An Investigation of R152a and Hydrocarbon Refrigerants in Mobile Air Conditioning by Mahmoud Ghodbane. The same investigator has further discussed the advantages of using secondary loop systems for automotive applications in SAE Publication No. 2000-01-1270 entitled On Vehicle Performance of a Secondary Loop A/C System.

Air conditioning systems for use in work vehicles such as agricultural tractors present unique challenges. Because such vehicles generate a great deal of heat in operation and are operated at much lower speeds for longer periods of time, the demand on the air conditioning system is much greater than that of on-highway passenger vehicles. Operator stations for such vehicles differ significantly from the passenger compartments of automobiles, for instance refrigerant lines are generally longer, the distance between air louvers and the operator is greater, as is the distance over which ductwork must be routed. Such ductwork is frequently routed past high heat components and thus the cooling capacity of the air being moved is degraded. Use of a single evaporator requires cross-sectionally large ductwork to reduce the pressure drop on the airside which consequently reduces visibility from inside the enclosure. Further, the amount of glass surrounding the operator station is greater so as to provide for optimal visibility during field operations and thus the solar heat load is significant. Additionally, efforts to meet new vehicle emissions regulations are demanding more and more horsepower and increasing the heat generated by the vehicle power plant. Thus it is becoming increasingly necessary to improve the efficiency of the air conditioning systems employed in such vehicles to reduce engine load while maintaining a high level of comfort for the operator.

### SUMMARY OF THE INVENTION

In view of the foregoing, it is an object of the invention to provide an operator cooling system for a work vehicle.

Another object of the invention is the provision of an operator cooling system that provides distributed cooling within the operator's enclosure of the vehicle.

A further object of the invention is to provide a distributed operator cooling system for a work vehicle which utilizes a secondary loop type A/C circuit.

An additional object of the invention is the provision of such a distributed operator cooling system which has improved efficiency over conventional vehicle cooling systems.

The foregoing and other objects of the invention together with the advantages thereof over the known art which will become apparent from the detailed specification which follows are attained by a distributed operator cooling system for a work vehicle comprising: a primary circuit utilizing a refrigerant, the primary circuit having a compressor, and a condenser; a secondary loop having a coolant pump for pumping a coolant to a plurality of coolant-air heat exchangers each having a blower fan associated therewith, wherein the secondary loop is coupled to the primary circuit by way of a coolant-refrigerant heat exchanger such that the coolant of the secondary loop is chilled by the refrigerant of the primary circuit; at least one coolant line to circulate chilled coolant to the coolant-air heat exchangers and at least one return line to circulate coolant back to the pump and coolant-refrigerant heat exchanger, the coolant and return lines being routed through the wall of an operator's enclosure; at least one of the coolant-air heat exchangers located in the forward area of the operator's enclosure in a front console of the vehicle substantially in front of an operator and at least one of the coolant-air heat exchangers located above and to the side, forward or aft of an operator's head; and, the blower fans associated with each coolant-air heat exchanger are individually controlled to optimize the flow of air through the coolant-air heat exchangers according to the needs of the operator.

Other objects of the invention are attained by an agricultural vehicle having: a vehicle frame; an operators station on the vehicle frame, the operator's station having an enclosure wall; a primary A/C circuit outside the operator's station; a secondary loop coupled to the primary circuit by a coolant-refrigerant heat exchanger; at least one coolant line and at least one return line passing through the enclosure wall of the operator's station, the at least one coolant line being connected to the coolant-refrigerant heat exchanger and the at least one return line being connected to a coolant pump of the secondary loop, the coolant pump being connected to the coolant-refrigerant heat exchanger; a plurality of coolant-air heat exchangers with blower fans associated therewith, the coolant-air heat exchangers distributed in various locations within the operator's station and being connected to the coolant and return lines; the coolant-refrigerant heat exchanger and the coolant pump are located outside the operator's station; whereby the coolant is chilled in the coolant-refrigerant heat exchanger and is pumped to the coolant-air heat exchangers inside the operators station for distributed cooling of an operator.

In general, a distributed operator cooling system is provided for a work vehicle. The system includes a primary circuit and a secondary loop. The primary circuit is a conventional A/C circuit having a compressor, a condenser, a receiver/dryer and an expansion valve. The secondary loop includes a coolant pump and a plurality of coolant-air heat exchangers each having a blower fan associated therewith. The secondary loop is coupled to the primary circuit by way of a coolant-refrigerant heat exchanger wherein the coolant of the secondary loop is chilled. Chilled coolant is circulated to the coolant-air heat exchangers by coolant lines and back to the pump and coolant-refrigerant heat exchanger by return lines. The coolant lines are routed through the wall of an operator's enclosure. At least one of the coolant-air heat exchangers is located in the forward area of the operator's enclosure in a front console of the vehicle substantially in front of the operator. A pair of coolant-air heat exchangers are located above and on either side, forward or aft of the operator's head. Additional heat exchangers can be provided at additional locations within the confines of the operator's enclosure for further distributed cooling and/or to compensate for potential hot spots within the cab. The blower fans associated with each coolant-air heat exchanger can be individually controlled to optimize the flow of air through the exchanger according to the needs of the operator. The use of multiple compact coolant-air heat exchangers positioned at multiple locations within the operator's enclosure allows for more efficient cooling than possible with a single large heat exchanger. The use of a secondary loop system allows for locating most of the system components remotely from the operators enclosure thereby reducing the risk of refrigerant contact with the operator and allows refrigerant lines to be shortened so as to improve the efficiency of the refrigerant cycle.

To acquaint persons skilled in the art most closely related to the present invention, one preferred embodiment of the invention that illustrates the best mode now contemplated for putting the invention into practice is described herein by and with reference to, the annexed drawings that form a part of the specification. The exemplary embodiment is described in detail without attempting to show all of the various forms and modifications in which the invention might be embodied. As such, the embodiment shown and described herein is illustrative, and as will become apparent to those skilled in the art, can be modified in numerous ways within the spirit and scope of the invention—the invention being measured by the appended claims and not by the details of the specification.

### BRIEF DESCRIPTION OF THE DRAWINGS

For a complete understanding of the objects, techniques, and structure of the invention reference should be made to the following detailed description and accompanying drawings, wherein:

FIG. 1 is a partially schematic view of the cooling system of the invention and its relationship to the operator's enclosure of a work vehicle.

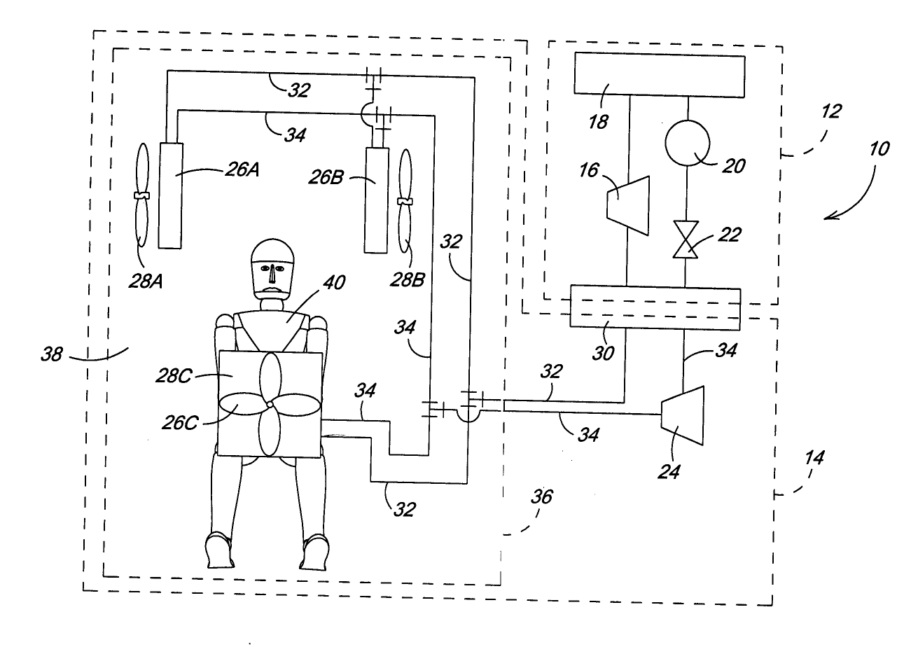

### DESCRIPTION OF THE PREFERRED EMBODIMENT

With reference now to the drawings it can be seen that a distributed operator cooling system for a work vehicle according to the invention is designated generally by the numeral 10. The system 10 generally includes a primary circuit 12 and a secondary loop 14. The primary circuit 12 is a conventional A/C circuit having a compressor 16, a condenser 18, a receiver/dryer 20 and an expansion valve 22. Those having skill in the art will recognize that it is possible to substitute an accumulator and orifice in place of the receiver/dryer and expansion valve illustrated. Such a configuration is not shown in the figures, but it should be understood that the arrangement of components of the primary circuit may necessarily vary from what is shown in the figures if such substitute components are employed. The primary circuit 12 preferably utilizes CO₂ or an HC or HFC refrigerant. The secondary loop 14 generally includes a coolant pump 24 and a plurality of coolant-air heat exchangers 26 each having a blower fan 28 associated therewith. The secondary loop 14 preferably uses a liquid coolant comprised of ethylene glycol or a glycol-water mixture. The secondary loop 14 is coupled to the primary circuit 12 by way of a coolant-refrigerant heat exchanger 30 wherein the coolant of the secondary loop 14 is chilled. Chilled coolant is circulated to the coolant-air heat exchangers 26 by coolant lines 32 and back to the pump 24 and coolant-refrigerant heat exchanger 30 by return lines 34. It will be noted that lines 32 and 34 are routed through the wall 36 of an operator's enclosure 38.

Preferably at least one of the coolant-air heat exchangers 26C is located in the forward area of the operator's enclosure 38 in a front console of the vehicle substantially in front of the operator 40 so as not to obstruct the operator's field of view. This position provides localized cooling for the operator 40 while still affording the operator 40 a generally unobstructed view out the front of the operator's enclosure 38. Likewise it is preferable to locate one or more of the coolant-air heat exchangers 26 above and to the side, forward or aft of the operator's head. This position provides additional localized cooling to the operator 40 without obstructing the operators field of view out the sides of the operator's enclosure 38. It would also be possible to locate a heat exchanger 26 directly above the operator's head, but for optimal head room it is preferred to utilize a pair of heat exchangers 26A and 26B above and on either side, forward or aft of the operator's head. It is also contemplated that additional heat exchangers could be provided at additional locations within the confines of the operator's enclosure for still further distributed cooling and/or to compensate for potential hot spots within the cab. It may further be desirable to utilize one or more control valves in the secondary loop 14 to selectively control the flow of coolant to the individual coolant-air heat exchangers 26. The blower fans 28 associated with each coolant-air heat exchanger 26 can be individually controlled to optimize the flow of air through the exchanger 26 according to the needs of the operator by use of fan speed controllers. It is also possible to utilize air louvers to control air flow from the blower fans 28. Because the heat exchangers 26 and blowers 28 are provided at multiple locations for localized or spot cooling it is possible to utilize smaller heat exchangers and blowers than would be possible if only a single heat exchanger were used. Similarly, the use of multiple compact heat exchangers positioned at multiple locations within the operator's enclosure allows for more efficient cooling than possible with a single large heat exchanger. The use of a secondary loop system allows for locating most of the system components remotely from the operators enclosure thereby reducing the risk of refrigerant contact with the operator. This also allows refrigerant lines to be shortened so as to improve the efficiency of the refrigerant cycle. The coolant-refrigerant heat exchanger operates more efficiently than conventional refrigerant-air heat exchangers thereby permitting the coolant to be cooled to a lower level than air. Further, coolant is more easily routed to other parts of the operator's enclosure for additional heat exchangers and localized cooling, and coolant is more easily controlled than a refrigerant when used at multiple locations.

Thus it can be seen that the objects of the invention have been satisfied by the structure presented above. While in accordance with the patent statutes, only the best mode and preferred embodiment of the invention has been presented and described in detail, it is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A distributed operator cooling system for a work vehicle comprising:
a primary circuit utilizing a refrigerant, the primary circuit having a compressor, and a condenser;
a secondary loop having a coolant pump for pumping a coolant to a plurality of coolant-air heat exchangers each having a blower fan associated therewith, wherein the secondary loop is coupled to the primary circuit by way of a coolant-refrigerant heat exchanger such that the coolant of the secondary loop is chilled by the refrigerant of the primary circuit;
at least one coolant line to circulate chilled coolant to the coolant-air heat exchangers and at least one return line to circulate coolant back to the pump and coolant-refrigerant heat exchanger, the coolant and return lines being routed through the wall of an operator's enclosure;
at least one of the coolant-air heat exchangers located in the forward area of the operator's enclosure in a front console of the vehicle substantially in front of an operator and at least one of the coolant-air heat exchangers located above and to the side, forward or aft of an operator's head; and,
the blower fans associated with each coolant-air heat exchanger are individually controlled to optimize the flow of air through the coolant-air heat exchangers according to the needs of the operator.

2. A distributed operator cooling system for a work vehicle according to claim 1 wherein the primary circuit further comprises a receiver/dryer and an expansion valve.

3. A distributed operator cooling system for a work vehicle according to claim 1 wherein the primary circuit further comprises an accumulator and an orifice.

4. A distributed operator cooling system for a work vehicle according to claim 1 wherein a pair of coolant-air heat exchangers are located above and on either side, forward or aft of the operator's head.

5. A distributed operator cooling system for a work vehicle according to claim 1 wherein at least one coolant-air heat exchanger is located directly above the operator's head.

6. A distributed operator cooling system for a work vehicle according to claim 4 wherein additional coolant-air heat exchangers are provided at additional locations within the confines of the operator's enclosure for further distributed cooling.

7. A distributed operator cooling system for a work vehicle according to claim 1 wherein a flow of coolant to and from the individual coolant-air heat exchangers is individually controlled by at least one control valve.

8. A distributed operator cooling system for a work vehicle according to claim 1 wherein each blower fan associated with each coolant-air heat exchanger has a speed control.

9. A distributed operator cooling system for a work vehicle according to claim 1 wherein louvers are provided for each blower fan associated with each coolant-air heat exchanger to control a flow of air from the blower fan.

10. A distributed operator cooling system for a work vehicle according to claim 1 wherein the refrigerant is CO₂.

11. A distributed operator cooling system for a work vehicle according to claim 1 wherein the refrigerant is an HC or HFC.

12. A distributed operator cooling system for a work vehicle according to claim 1 wherein the coolant is a liquid.

13. A distributed operator cooling system for a work vehicle according to claim 1 wherein the coolant is a glycol-water mixture.

14. A distributed operator cooling system for a work vehicle according to claim 1 wherein the coolant is ethylene glycol.

15. A distributed operator cooling system for a work vehicle according to claim 1 wherein the primary circuit is located outside the operator's enclosure.

16. An agricultural vehicle having:
a vehicle frame;
an operators station on the vehicle frame, the operator's station having an enclosure wall;
a primary A/C circuit outside the operator's station;
a secondary loop coupled to the primary circuit by a coolant-refrigerant heat exchanger;
at least one coolant line and at least one return line passing through the enclosure wall of the operator's station, the at least one coolant line being connected to the coolant-refrigerant heat exchanger and the at least one return line being connected to a coolant pump of the secondary loop, the coolant pump being connected to the coolant-refrigerant heat exchanger;
a plurality of coolant-air heat exchangers with blower fans associated therewith, the coolant-air heat exchangers distributed in various locations within the operator's station and being connected to the coolant and return lines;
the coolant-refrigerant heat exchanger and the coolant pump are located outside the operator's station;
whereby the coolant is chilled in the coolant-refrigerant heat exchanger and is pumped to the coolant-air heat exchangers inside the operators station for distributed cooling of an operator.

17. An agricultural vehicle according to claim 16 wherein at least one coolant-air heat exchanger is located directly above the operator's head.

18. An agricultural vehicle according to claim 16 wherein a pair of coolant-air heat exchangers are located above and on either side, forward or aft of the operator's head.

19. An agricultural vehicle according to claim 16 wherein at least one of the coolant-air heat exchangers is located in the forward area of the operator's enclosure in a front console substantially in front of an operator.

20. An agricultural vehicle according to claim 16 wherein a flow of coolant to and from the individual coolant-air heat exchangers is individually controlled by at least one control valve.

21. An agricultural vehicle according to claim 16 wherein each blower fan associated with each coolant-air heat exchanger has a speed control.

22. An agricultural vehicle according to claim 16 wherein louvers are provided for each blower fan associated with each coolant-air heat exchanger to control a flow of air from the blower fan.

23. An agricultural vehicle according to claim 16 wherein the refrigerant is CO₂.

24. An agricultural vehicle according to claim 16 wherein the refrigerant is an HC or HFC.

25. An agricultural vehicle according to claim 16 wherein the coolant is a liquid.

26. An agricultural vehicle according to claim 16 wherein the coolant is a glycol-water mixture.

27. An agricultural vehicle according to claim 16 wherein the coolant is ethylene glycol.
